(19) United States
(12) Patent Application Publication
(10) Pub. No.: US 2026/0056286 A1
(43) Pub. Date: Feb. 26, 2026

(54) Aerial Polarization-Imaging System and Method for Detection of Subsurface Fish

(71) Applicant: Vincent Loccisano, Wellesley, MA (US)

(72) Inventor: Vincent Loccisano, Wellesley, MA (US)

(21) Appl. No.: 19/379,053

(22) Filed: Nov. 4, 2025

(51) Int. Cl. G01S 7/02; G01C 21/16; G01S 13/86; G01S 13/89

(52) U.S. Cl. CPC G01S 7/025; G01C 21/1652; G01S 7/027; G01S 13/862; G01S 13/867; G01S 13/89

(57) ABSTRACT

An aerial polarimetric fish-detection system and method acquire polarization-resolved imagery from an elevated platform over a water area, compute per-pixel polarization metrics (degree and angle of linear polarization), compensate for viewing geometry and environmental factors, and detect candidate subsurface scatterers consistent with fish via spatial and temporal anomaly analysis. The system geolocates candidate fish positions, estimates confidence and depth proxies, and add more details about how the polarization may happen to allow seeing below the surface and reducing glare.

### TECHNICAL FIELD OF THE INVENTION

The present invention relates generally to the field of remote sensing and environmental monitoring. More specifically, it pertains to an aerial system and method for the detection and localization of fish and other biological entities residing beneath the surface of a body of water.

### BACKGROUND OF THE INVENTION

The detection of aquatic life is seen in various fields including commercial fishing, recreational angling and ecological research. Traditional methods include visual observation from a boat or aircraft and acoustic methods. Sound Navigation and Ranging (SONAR) is widely used in commercial and recreational fish finding products. While SONAR can detect objects in a water column and provide depth information it typically has a limited field of view, offering data only for the area directly beneath a SONAR transducer. Acoustic methods are less effective in shallow waters and are unable to provide visual confirmation of classification of the detected targets.

The detection of productive distant patches of fish, subtle subsurface activity or thermal features that concentrate fish are also problematic due to the limited range or coverage limits of SONAR devices.

Although the advent of Unmanned Aerial Vehicles (UAVs) or drones, there has been a growing interest in using conventional aerial imaging for fish spotting using standard cameras. These systems suffer from the same fundamental limitations as direct visual observation including surface glare and water surface turbidity. UAVs can extend the operator's sensory reach, but systems tailored for fishing must integrate multi-modal sensing, real-time analytics, robust boat deployment/retrieval, and seamless delivery of guidance to existing marine multifunction displays under marine operating constraints.

### SUMMARY OF THE INVENTION

The present invention is directed to a vessel-deployed system and method for remotely identifying productive fishing locations beyond the direct visual range of a vessel operator. The system addresses the fundamental limitation of anglers being able to see and sense only their immediate surroundings, thereby significantly extending their effective search area and increasing the probability of locating fish

A boat-deployed UAV system includes a vessel-mountable launch and recovery subsystem; a UAV payload including at least one camera configured for multispectral/polarimetric imaging, thermal imaging, a short-range radar or microwave sensor, onboard GNSS/IMU for georeferencing; a communications subsystem for low-latency streaming to an onboard multifunction device. Options include downward-looking sonar/altimeter or active acoustic device for measuring altitude.

A processing subsystem may be onboard the UAV, or may be transferred to a boat-based computer, or cloud. The system detects surface fish action such as breaking, splashes, baitfish schools. Subsurface fish activity may be discerned by detecting swim-bladder specularities, wakes, polarization-derived subsurface signatures, acoustic returns, and the like. Surface and subsurface temperature anomalies such as thermal fronts, thermoclines, upwellings may be detected using thermal and multispectral data processing. Bird feeding aggregations and behavior indicative of forage and predatory fish are visually detected.

The system geolocates detections, ranks/prioritizes targets, generates recommended waypoints/approach vectors, and streams live video. In some embodiments, annotated maps, and alerts may be sent to an onboard multifunction device integrated with vessel GPS, charting, and radar/traffic displays.

The system is made up of an unmanned aerial vehicle (UAV) that is deployed from and recovered by a specialized launch and recovery subsystem mounted to a fishing vessel. The UAV is equipped with a stabilized, multi-modal imaging payload designed to capture a variety of fish-indicating signatures. In a primary embodiment, this payload includes at least one visible-band camera for detecting surface activity like feeding frenzies, and at least one thermal camera for identifying sea surface temperature anomalies, such as thermal fronts or upwellings, which are known to aggregate baitfish and predatory game fish. A high-precision positioning subsystem, including a GNSS and an inertial measurement unit (IMU), ensures all collected sensor data is accurately georeferenced.

Data captured by the UAV's sensors is streamed in real-time via a communications subsystem to an onboard detection processing subsystem located on the vessel. This processing subsystem acts as the analytical core of the invention. It is configured to apply sophisticated detection algorithms to the incoming sensor data to automatically identify one or more key indicators of fish presence. These indicators include not only direct detection of surface or subsurface fish but also indirect cues like aggregations of feeding birds, which are a strong correlate of baitfish schools.

A key aspect of the invention is the fusion of data from multiple sensors to enhance detection confidence and reduce false positives. The processing subsystem can compute a confidence score for each detected area of interest and rank the resulting waypoints based on factors such as the strength of the detection cues and the distance from the vessel. Advanced embodiments may employ polarimetric or multi-angle imaging, coupled with Fresnel-based surface reflection compensation, to improve the detection of fish beneath the water's surface by mitigating glare.

The processed output, including live sensor feeds, detection overlays, and ranked, georeferenced waypoints, is presented to the vessel operator through an intuitive interface module. This module is designed to integrate seamlessly with standard onboard marine electronics, such as multifunction displays (MFDs), by communicating over industry-standard protocols like NMEA or Ethernet. This allows the system to overlay detection markers directly onto the vessel's existing nautical charts and radar layers, enabling the operator to easily visualize the location of potential fishing spots and navigate to them efficiently. The system may further provide recommended approach vectors for the generated waypoints and can incorporate machine learning by logging operator outcomes to continuously refine its detection models.

The system extends visual and SONAR reach beyond the line-of-sight from a boat and fuses complementary sensors to reduce false positive results by discriminating boats, floating debris and wave glint. The system further delivers guidance directly to commonly used onboard displays for immediate angler action while supporting real-time decisions regarding repositioning, bait selection or casting location.

### BRIEF DESCRIPTION OF DRAWINGS

FIG. 1 is a perspective view of an example embodiment including a UAV on a launch and recovery cradle mounted to a vessel in communication with an onboard computer and multifunction display with telemetry links;

FIG. 2 is a diagram of a UAV payload including RGB/zoom camera, multispectral/polarimetric and thermal imaging devices, short-range radar, GNSS/IMU, and communication apparatus;

FIG. 3 is a diagram of a method for identifying targets.

FIG. 4 is a plan view depicting sensor coverage and detection overlays including surface action, subsurface mapping, thermal mapping, bird detections and recommended waypoints.

FIG. 5 is diagram depicting data flow including data capture→preprocessing→feature extraction→detection/classification→geolocation→user interface/stream.

### DETAILED DESCRIPTION OF THE INVENTION

Example embodiments enable fishing vessels to deploy a UAV to survey remote watery areas and to provide the angler with real-time, georeferenced intelligence relating to evidence of the presence of fish beyond a visual range. The UAV carries multiple complementary sensors that may be onboard the UAV, on the boat or linked to a cloud processing platform. The sensor data is processed by advanced detection and fusion algorithms to identify high-probability targets. Finally, the results, including live media and target locations, are streamed to the angler's onboard multifunction device to guide navigation and strategy

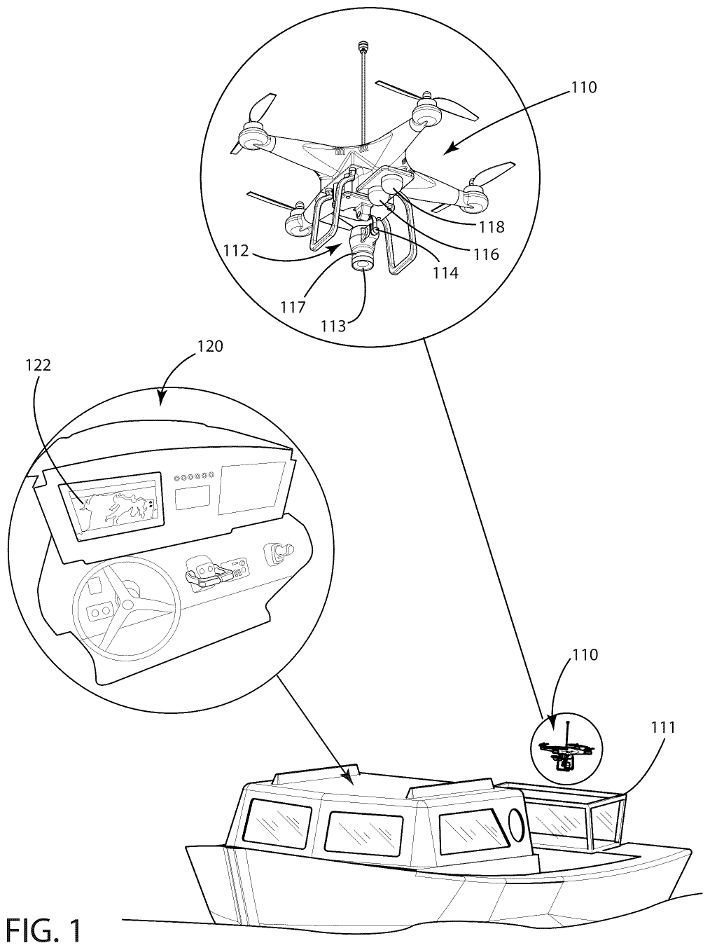

FIG. 1 depicts a launch and recovery cradle 111 removably attached to a portion of a fishing boat. In some embodiments a net or retrieval assist, or robotic recovery arm is included. Many embodiments include a docking station for automated charging, communication ports and the like. Although various unmanned aerial vehicles may be employed the present illustrations depict a multirotor UAV 110. Vertical Take Off and Landing vehicles may be employed, or small fixed wing aircraft may also be used within the scope of the invention. The vehicle may include a visible RGB camera 112 having a high resolution and zoom lens with a high frame-rate video capability for dynamic detection. The camera is capable of processing radiometric thermal imaging for sea surface temperature (SST) mapping, detection of thermal anomalies, near-surface thermocline signatures and the like. The camera 112 is equipped with a polarizer 117 engaged with a camera lens 113. A stabilization gimbal 114 supports the camera and positions and orients the camera to acquire images at one or more polarization angles and exposure set.

The UAV is further equipped with short-range radar 116 in the form of small-form millimeter-wave or micro-doppler radar to detect surface breaking, splashes, bird flocks and to sense wave patterns or to navigate in fog. In some embodiments a SONAR apparatus 118 senses subsurface schools of fish. An anemometer 120 includes environmental sensors to sense wind speed and direction, ambient light, barometric pressure and the like.

To ensure a continuous, low-latency data stream, the system features a redundant, dual-link communication architecture, utilizing both direct radio frequencies (2.4/5.8 GHz) for short-range operations and cellular networks (LTE/5G) for long-range connectivity where available. This live telemetry, along with processed detection overlays, is received by an onboard computer or an embedded gateway in the control center 120 on the vessel. This hub then seamlessly interfaces with the boat's primary multifunction device (MFD) 122 using standard marine protocols like NMEA 0183/2000 or Ethernet. This deep integration allows for the direct injection of waypoints and track markers onto nautical charts and the layering of thermal or detection data over existing radar screens, providing the operator with unified controls and clear approach guidance to the target.

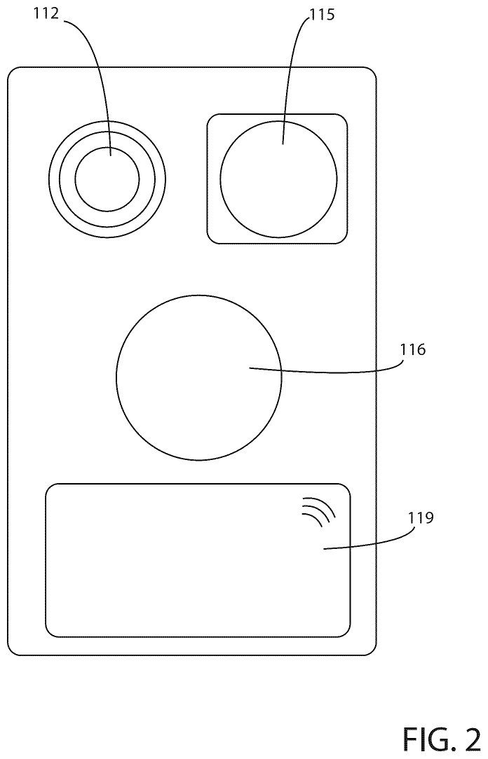

FIG. 2 is a diagram of a UAV payload including RGB/zoom camera 112, multispectral/polarimetric and thermal imaging devices 115, short-range radar, GNSS/IMU 116, and communication apparatus 119. One skilled in the art understands that in some embodiments, a camera 112 may be configured to capture thermal images while in other embodiments a separate camera, dedicated to thermal imaging, may be included. FIG. 1 depicts a camera 112 configured for both RGB/zoom and for thermal imaging 115. FIG. 2 diagrams a dedicated thermal imaging apparatus 115 along side a visual camera 112.

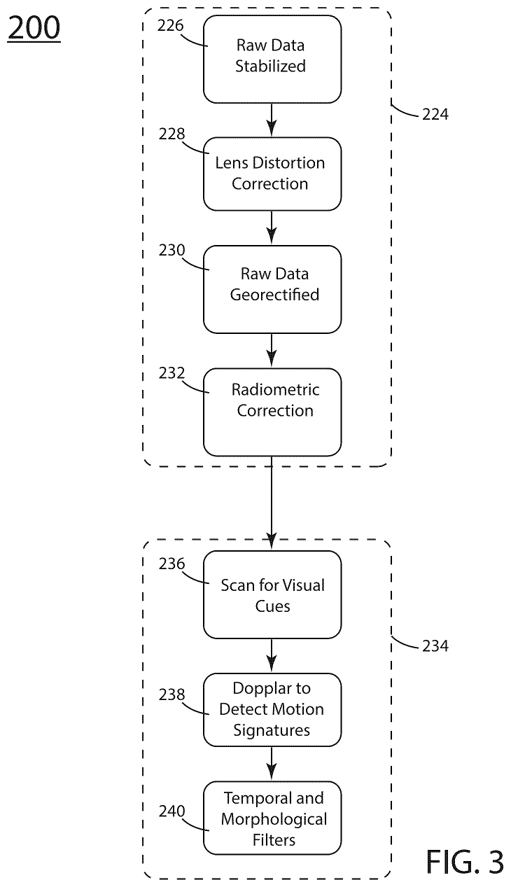

FIG. 3 is a diagram of a method for identifying targets 200, also referred to as the system's processing pipeline, begins with a crucial preprocessing stage 224. Raw data from the UAV's sensors is first stabilized 226, corrected for lens distortion 228, and precisely georectified 230 using its GNSS and IMU data. Thermal imagery undergoes additional radiometric correction 232 to account for atmospheric effects and surface emissivity, ensuring accurate temperature readings.

Once this clean, referenced data is ready, a suite of advanced detection algorithms is applied to find signs of surface activity 234. Computer vision models scan the video feeds for visual cues 236 like splashes, whitewater, surface disturbances and the distinct shimmer of schooling baitfish. Simultaneously, radar micro-Doppler is used to detect the unique motion signatures 238 of bird flocks and feeding events. To ensure accuracy, the system employs temporal and morphological filters 240 to analyze motion over time, effectively distinguishing brief, transient feeding events from the repetitive pattern of ocean waves and thus minimizing false positives.

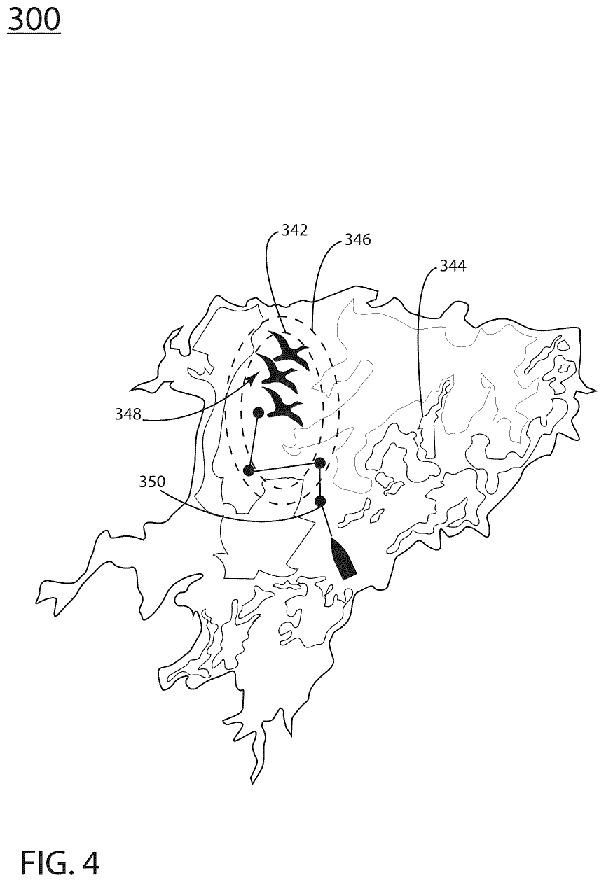

FIG. 4 is a plan view depicting sensor coverage and detection overlays including surface action 342, subsurface mapping 344, thermal mapping 346, bird detections 348 and recommended waypoints 350.

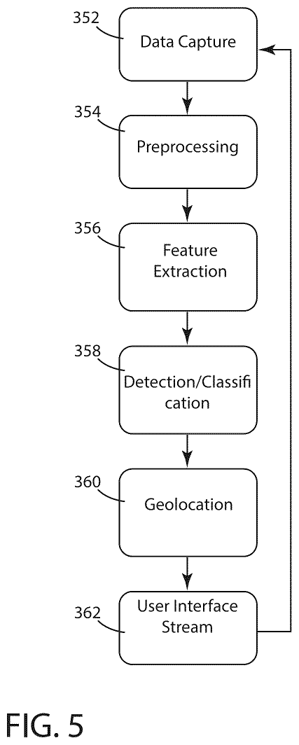

FIG. 5 is diagram depicting data flow including data capture 352→preprocessing 354→feature extraction 356→detection/classification 358→geolocation 360→user interface/stream 362.

Detecting subsurface activity relies on a multi-model approach. The system primarily leverages polarimetric and multispectral analysis to identify submerged targets by exploiting how they alter underwater light scattering which creates unique signatures like a reduced degree of polarization. This optical analysis is complemented by thermal imaging which measures spatial temperature gradients to locate anomalies associated with upwellings or shallow thermoclines known to attract and hold fish.

For more direct confirmation, the system may incorporate data from optional downward-looking SONAR 118 or acoustic sensors. Sophisticated motion and wake analysis of sequential video frames may reveal the subtle surface disturbances such as small bow wakes or current perturbations that are signs of fish swimming just below the surface.

Temperature mapping is processed by creating georeferenced SST mosaics from thermal imagery, detecting gradients and localized cool or warm patches of water by computing spatial derivatives (VT) and thresholding for candidate holding zones. The system further estimates subsurface thermal layers by combining multispectral attenuation and thermal surface patterns. This may optionally be augmented with vessel-mounted conductivity/temperature/depth (CTD) data.

Bird behavior is an important visual clue determinate of fish activity. The system detects and classifies avian flocks, their dive behavior and circling patterns using captured images from the camera 112 and short-range radar 116. The images are correlated with the bird positions over time with surface and subsurface detections to generate a confidence factor.

A sensor fusion and scoring engine combines multi-modal cues including visual splash, nearby thermal fronts, bird activity and polarimetric subsurface signatures to generate a unified detection confidence score. This is accomplished using methods such as Bayesian fusion or supervised machine learning models trained on extensive fishing event data. These scored detections are automatically ranked and prioritized based not only on the confidence score but also on practical factors like distance and accessibility from the vessel, ensuring the angler is always presented with the most promising and actionable targets first.

Once a target is identified, the system translates its pixel location into georeferenced coordinates, generating actionable guidance including waypoints, suggested casting points and range, bearing and estimated time or arrival. This data may be automatically displayed on a vessel's Multifunction Device (MFD) 122.

The multi-layered interface displayed on the MFD includes live, stabilized video with a confidence score, interactive thermal map tiles, and a geolocated list of prioritized waypoints. Audible and visual alerts provide high confidence notification of feeding events detected beyond the normal visual range from a boat.

Missions are conducted within a flexible flight envelope with altitudes typically ranging from 10-200 m and survey radii tailored to the vessel's needs and local regulations. The launch and recovery workflow is streamlined for marine environments featuring a hands-free launch and capture cradle 111 for safe recovery in rough seas.

1. A vessel-deployed remote fish-finding system comprising:
a launch and recovery subsystem mountable to a fishing vessel; and
an unmanned aerial vehicle (UAV) deployable from the launch and recovery subsystem, the UAV comprising:
a stabilized, multi-modal sensor payload including at least one camera configured for visible-band camera and thermal imaging; and
a positioning subsystem comprising a Global Navigation Satellite System (GNSS) and an inertial measurement unit (IMU); and
a communications subsystem configured to stream sensor data from the UAV to the vessel; and
a detection processing subsystem configured to:
receive the sensor data from the UAV; and
detect, using the sensor data, a plurality of fish-indicating cues from a group consisting of (i) surface fish action, (ii) subsurface fish activity, (iii) sea surface thermal anomalies, and (iv) bird feeding behavior in an area beyond a direct visual range of the vessel; and
generate one or more georeferenced waypoints corresponding to one or more detected areas of interest; and
an interface module configured to present the georeferenced waypoints and live sensor data on a multifunction device (MFD) integrated with the vessel's navigation systems.

2. The system of claim 1 wherein:
the UAV sensor payload further comprises a polarimetric imager, and wherein the detection processing subsystem is further configured to detect subsurface fish activity by applying Fresnel-based surface reflection compensation to polarimetric image data.

3. The system of claim 1 wherein:
the UAV sensor payload further comprises a short-range radar, and wherein the detection processing subsystem is further configured to detect at least one of surface fish action and bird feeding behavior using micro-Doppler radar returns.

4. The system of claim 1 wherein:
the detection processing subsystem is further configured to execute a sensor fusion model to combine two or more distinct fish-indicating cues detected within a common area of interest to compute a unified detection confidence score for the area of interest.

5. The system of claim 4 wherein:
the detection processing subsystem is further configured to rank a plurality of georeferenced waypoints based at least in part on the computed detection confidence score and a distance from the vessel.

6. The system of claim 1 wherein:
the detection processing subsystem is further configured to identify bird aggregations via at least one of computer vision and radar, and to correlate a location of the bird aggregations with a location of a subsurface detection to increase a confidence factor for a target.

7. The system of claim 1 wherein:
the interface module is configured to automatically inject the georeferenced waypoints into the vessel's navigation systems for routing via an NMEA or Ethernet protocol and to overlay detection markers on at least one of a nautical chart and a radar display of the MFD.

8. The system of claim 1 wherein:
the detection processing subsystem is further configured to log operator outcomes associated with a georeferenced waypoint, including a catch or no-catch confirmation, to generate labeled training data for refining a detection model.

9. A method for providing remote fishing guidance from a vessel, the method comprising:
deploying an unmanned aerial vehicle (UAV) from a launch and recovery subsystem mounted to the vessel, the UAV comprising a multi-modal sensor payload; and
capturing, with the multi-modal sensor payload, sensor data of a remote water area, the sensor data including at least visible imagery and thermal imagery; and
transmitting the sensor data from the UAV to an onboard processing subsystem; and
detecting, using the processing subsystem, a plurality of fish-indicating cues within the sensor data; and
fusing, with the processing subsystem, two or more of the detected fish-indicating cues to generate a confidence-scored detection for an area of interest; and
generating one or more georeferenced waypoints corresponding to the confidence-scored detection; and
streaming the georeferenced waypoints and live sensor data to an onboard multifunction device (MFD) for presentation to a vessel operator.

10. The method of claim 9 further comprising:
preprocessing the sensor data prior to detecting the plurality of fish-indicating cues, wherein preprocessing includes stabilizing the sensor data, correcting for lens distortion, and georectifying the sensor data using positioning data from the UAV.

11. The method of claim 9 wherein:
capturing sensor data further comprises capturing polarimetric imagery, and wherein detecting the plurality of fish-indicating cues comprises detecting subsurface targets by analyzing changes in underwater light scattering within the polarimetric imagery.

12. The method of claim 9 wherein:
capturing sensor data further comprises:
capturing short-range radar data, and wherein detecting the plurality of fish-indicating cues comprises detecting bird flocks and surface splashes using micro-Doppler analysis of the radar data.

13. The method of claim 9 further comprising:
generating, for a georeferenced waypoint, a recommended approach vector and a suggested casting point for an angler.

14. The method of claim 9 further comprising:
issuing, via the MFD, an audible or visual alert in response to a confidence-scored detection exceeding a predetermined threshold.

15. A non-transitory computer-readable medium storing instructions which, when executed by one or more processors, cause the processors to perform a method comprising:
receiving a plurality of streamed sensor data feeds from a multi-modal sensor payload of a UAV deployed from a vessel, the sensor data feeds including at least a visible-band video feed and a thermal data feed; and
applying a plurality of detection algorithms to the sensor data feeds to identify a plurality of fish-indicating cues in a remote water area; and
executing a sensor fusion model to combine two or more distinct fish-indicating cues that are spatially correlated to compute a confidence score for an area of interest; and
generating a georeferenced waypoint corresponding to the area of interest; and
transmitting the georeferenced waypoint and an annotated video feed to a multifunction device onboard the vessel for display.
